(19) United States
(12) Patent Application Publication
(10) Pub. No.: US 2024/0240093 A1
(43) Pub. Date: Jul. 18, 2024

(54) TWO-STAGE PLASMA PROCESS FOR CONVERTING WASTE INTO FUEL GAS AND APPARATUS THEREFOR

(71) Applicant: PYROGENESIS CANADA INC., Montreal (CA)

(72) Inventors: Pierre CARABIN, Montreal (CA); Peter George TSANTRIZOS, Montreal (CA)

(21) Appl. No.: 18/451,442

(22) Filed: Aug. 17, 2023

Related U.S. Application Data
(63) Continuation of application No. 17/729,664, filed on Apr. 26, 2022, now abandoned.
Application No. 17/729,664 is a continuation of application No. 16/657,727, filed on Oct. 18, 2019, now abandoned.
Application No. 16/657,727 is a continuation of application No. 15/722,442, filed on Oct. 2, 2017, now abandoned.
Application No. 15/722,442 is a continuation of application No. 14/264,886, filed on Apr. 29, 2014, now abandoned.
Application No. 14/264,886 is a continuation of application No. 12/830,818, filed on Jul. 6, 2010, now abandoned.
Application No. 12/830,818 is a continuation of application No. 10/552,119, filed on Oct. 27, 2006, now abandoned.

(30) Foreign Application Priority Data
Apr. 4, 2003 (CA) 2424805

(51) Int. Cl. C10J 3/18; C10J 3/46; C10J 3/57; C10J 3/72; C10J 3/84

(52) U.S. Cl. CPC C10J 3/18; C10J 3/466; C10J 3/57; C10J 3/721; C10J 3/845; C10J 2200/12; C10J 2300/094; C10J 2300/095; C10J 2300/1238; C10J 2300/1634; C10J 2300/1807

(57) ABSTRACT

A two-step gasification process and apparatus for the conversion of solid or liquid organic waste into clean fuel, suitable for use in a gas engine or a gas burner, is described. The waste is fed initially into a primary gasifier, which is a graphite arc furnace. Within the primary gasifier, the organic components of the waste are mixed with a predetermined amount of air, oxygen or steam, and converted into volatiles and soot. The volatiles consist mainly of carbon monoxide and hydrogen, and may include a variety of other hydrocarbons and some fly ash. The gas exiting the primary gasifier first passes through a hot cyclone, where some of the soot and most of the fly ash is collected and returned to the primary gasifier. The remaining soot along with the volatile organic compounds is further treated in a secondary gasifier where the soot and the volatile compounds mix with a high temperature plasma jet and a metered amount of air, oxygen or steam, and are converted into a synthesis gas consisting primarily of carbon monoxide and hydrogen. The synthesis gas is then quenched and cleaned to form a clean fuel gas suitable for use in a gas engine or a gas burner. This offers higher thermal efficiency than conventional technology and produces a cleaner fuel than other known alternatives.

### BACKGROUND OF THE INVENTION

### 1. Field of the Invention

The present invention relates to a method and apparatus for a two-stage conversion of organic components contained in solid and/or liquid waste, at high plasma temperature, into a fuel gas suitable for use in a gas engine or turbine for the production of electricity or a gas burner for the production of steam, or in chemical synthesis reactions.

### 2: Description of the Prior Art

Numerous methods have been proposed for the conversion of waste into energy. The most common method is incineration. In incineration systems, waste is typically introduced in a high temperature chamber and reacted with large amounts of air. The process can be one stage or two stages. Whether the incineration process is one stage or two stages, the process always uses large amounts of air, resulting in the production of large amounts of hot off-gas, typically laden with entrained particulates and acid gas components. Thermal energy is typically extracted from this hot dust-laden acid gas using a heat recovery boiler.

This method of extracting energy from a hot dirty gas is subject to two main problems. First, heat recovery boilers are subject to corrosion from the acid gas and fouling from the particulates, especially above temperatures of 700° ° C. Second, the slow cooling of gas in a recovery boiler is the major cause for the de novo synthesis of dioxins that occurs in the temperature range of 250-400° C. (c.f. Cernuschi et al., “PCDD/F and Trace Metals Balance in a MSW Incineration Full Scale Plant”, Proceeding of the 2000 International Conference on Incineration and Thermal Treatment Technologies). Thus, energy cannot be safely recovered at temperatures below 400° C. because of the risk of forming dioxins. In a typical incinerator, gases exit the main incineration chamber at 1100° ° C. and exit the chimney at 150° C. Of this range, energy can only be practically and safely recovered in the range from 700 to 400° C., meaning that only about one third of the available energy can be recovered. Solutions have been proposed to alleviate some of these problems in incineration. For example, U.S. Pat. No. 5,092,254 of Kubin et al. proposes a process whereby lime is injected in the incinerator to neutralize the acid gases and reduce corrosion level inside the incinerator and auxiliary equipment. U.S. Pat. No. 5,797,336 of Müller et al. discloses a process for the incineration of waste material whereby waste is first incinerated in a furnace chamber, then re-burnt in a fluidized bed afterburning chamber, in order to reduce the number of particulates, and go to a heat recovery boiler where the gas temperature is reduced from 700-1100° C. to 100-300° C. Fundamentally, however, all incineration systems try to extract energy from a hot dirty gas.

Also, by using an independent source of heating, such as plasma, a wide range of waste types can be combusted, independently of their composition. The plasma also allows reaching high temperatures that will melt the inorganic components of the waste into an inert slag and will dissociate them from the organic components of the waste, which will form a gas.

A number of methods and apparatus have been proposed for the decomposition of wastes, hazardous or not, into inert slag and non-hazardous gases with the use of plasma. Thus, U.S. Pat. No. 4,960,380 of Cheetham describes a two-step process, wherein in the first step plasma is used to reduce solid waste materials to a slag-like material from which more harmful constituents have been removed and to a gaseous effluvium. The effluvium of the plasma reduction process is scrubbed to remove particulates. The gas is then processed by additional heating and oxygen addition in order to convert the carbon monoxide in the gas into carbon dioxide. Products of incomplete combustion (and/or chemically harmful constituents) are also eliminated in this step. The oxidized gas is then suitable for safely exhausting into the atmosphere. In this system, coherent radiation (laser) is used to generate and sustain the plasma. This process is targeted at treating low organic content waste, such as incinerator ash. Moreover, the gas exhausted from the process being a hot combustion gas, the problems associated with incineration, described above, also apply to this process.

A plasma torch can also be used as an independent source of heat. For example, U.S. Pat. No. 5,534,659 of Springer et al. describes a single step method and an apparatus for treating hazardous and non-hazardous waste materials composed of organic and inorganic components by subjecting them to high temperature pyrolysis and controlled gasification of organic materials and metals recovery and/or vitrification of inorganic materials. The source of heating for the reactor is a conventional plasma arc torch.

U.S. Pat. No. 5,451,738 of Alvi et al. provides a two-step method for the disposal of waste material, including volatile components and vitrifiable components, by first heating the waste to vaporize the hydrocarbon liquids and thereafter feeding to a primary plasma reactor on the surface of a molten pool where the vitrifiable components are melted and the volatile components are volatilized. The reactor is equipped with multiple AC plasma torches. The torches use copper electrodes, which are water-cooled. The hydrocarbon liquids and the volatilized components are then fed to a secondary plasma reactor where they are dissociated into their elemental components.

The use of a plasma torch in order to obtain high reaction temperatures in the gas phase poses some problems. Plasma torches have relatively low energy efficiency, whereby 30 to 40% of the electric energy to the torch is typically lost to cool the electrodes. Moreover, the water-cooled torch presents the risk of water leaks onto the molten slag inside the reactor, creating an explosion. By contrast, considerable improvement is produced by using graphite rods to generate the plasma in an arc furnace, since graphite can withstand extremely high temperatures (several thousands of degrees), no water cooling is required and the energy efficiency of the graphite rod is nearly 100%. Also, the risk of water leaking into the furnace is eliminated because the graphite rods need no cooling.

For example, U.S. Pat. No. 4,431,612 by Bell et al. describes a single step method and an apparatus for treatment of solid, liquid and gaseous PCB's as well as other hazardous materials by introducing them into a chamber and into contact with a molten bath maintained in such chamber by a DC electric arc, which maintains the temperature in excess of 1600° C. The obtained molten bath serves to promote the initial decomposition or volatilization of PCB's and other hazardous materials, resulting in a gaseous product that comprises CO, CO₂, H₂, CH₄ and HCl.

However, Bell et al. do not try to produce fuel gas from waste. Instead, their objective is to dissociate the waste into simple molecules. This process of dissociation does not use oxygen addition and is done in one step. Hence, this process and similar processes will lead to the production of large amounts of carbon soot.

The production of soot under these reducing conditions is well known as was shown in U.S. Pat. No. 5,451,738 by Alvi et al. that identified this problem and tried to alleviate it by catching the carbon black (soot) in a cyclonic scrubber. Similarly, in U.S. Pat. No. 5,534,659 of Springer et al. the problem of soot formation is recognized and oxidant injection is used to convert the soot to carbon monoxide.

### SUMMARY OF THE INVENTION

In order to recover energy from waste in a clean and efficient way, a technology different than incineration is proposed. In a gasification system using plasma, waste is converted to a fuel gas consisting mainly of carbon monoxide and hydrogen, by beating up the waste in an oxygen-starved atmosphere. The gas produced is then cleaned of contaminants such as soot, before it can be used as fuel to produce electricity or steam.

In a gasification system, most of the energy from the waste is stored in the form of chemical energy instead of sensible (or thermal) energy as is the case in an incineration system. The amount of gas produced by a gasification system is typically four to five times less than the gas produced in an incineration system. This gives the possibility of quenching the gas from the gasification temperatures (800 to 1100° ° C. depending on system) down to below saturation using water quenching. This approach eliminates the problem of dioxin formation, which occurs in the 250 to 400° C. range.

The objective of the present invention is to convert essentially all the waste to fuel gas. For this purpose, in addition to a primary gasifier, where initial conversion of waste into fuel gas takes place, there is a need for a second stage gasifier to convert the carbon soot in the gas to gaseous carbon monoxide; this second stage includes the addition of metered amounts of oxygen into the gasifier.

The energy efficiency is higher when air is added to gasify the waste, namely by reacting the waste with oxygen, rather than simply dissociating the waste into simple molecules. The chemical energy of the products of dissociation is typically much higher than the chemical energy of the waste being treated. This means that significant amounts of electrical energy must be used for dissociation. In the present invention, by adding carefully metered amounts of oxygen or air and/or steam to the process, it is possible to limit the amount of electrical (or plasma) energy required for dissociation. In fact, the amount of oxygen fed can be increased so that partial combustion of the waste occurs and the plasma requirements are much reduced. Electrical energy is an expensive form of energy and it is important to use it as efficiently as possible.

By contrast to known plasma waste treatment systems, in the present invention the plasma energy serves mainly two purposes: 1) to vitrify (or melt) the inorganic portion of waste in the primary gasifier while partially gasifying the organic components, and 2) to provide the activation energy to complete the gasification reactions in the secondary gasifier.

In essence, therefore, the present invention provides a two-stage plasma process for converting waste having organic and inorganic components into fuel gas, which comprises:
(a) in the first stage, vitrifying or melting the inorganic components of the waste and partially gasifying the organic components; and
(b) in the second stage, completing the gasification of the organic components so as to convert them into fuel gas.

Moreover, a dust separation and removal step is normally provided between the two stages of the process.

Furthermore, the fuel gas produced in the second stage is usually quenched and cleaned to make it suitable for use in a gas engine or turbine for production of electricity or in a gas burner for production of steam or in chemical synthesis reactions.

Generally, the first stage is carried out in a plasma arc furnace, and the second stage is carried out in a secondary gasifier using a plasma torch with addition of metered amounts of oxygen. The plasma arc furnace is preferably a refractory lined, enclosed furnace provided with at least one direct current graphite electrode adapted to generate a plasma are to a bath of liquid inorganic material originating from the waste itself and located at the bottom of the furnace. This liquid inorganic material comprises a slag layer which is maintained at a temperature of at least 1500° C., usually a temperature between 1500° ° C. and 1650° ° C., and a metal layer also maintained at such temperature of at least 1500° C. and is located under the slag layer.

The waste is introduced into the furnace on top of the liquid inorganic material and the organic component in the waste reacts with air, oxygen and/or steam supplied to the furnace in a predetermined amount adapted to achieve gasification of the organics in the waste into a primary synthesis gas containing CO, H₂, CO₂ and N₂ if the waste contains nitrogen or if air is added to the furnace, and also containing some soot, fly ash and complex organic molecules. The organic material in the waste is preferably reacted in the furnace so as to form a layer of partially treated waste on top of the slag layer and fresh waste is introduced into the furnace on top of said partially treated waste layer which is maintained at a temperature of between 700 and 800° C. and constitutes a cold top for the fresh waste added to the furnace. The primary synthesis gas exiting from the furnace is subjected to dust separation and removal in which dust particles larger than a predetermined size are separated and removed. These dust particles are then normally recycled to the furnace, while the remainder of the gas is fed to the secondary gasifier.

The secondary gasifier is preferably equipped with a plasma torch fired eductor which ensures that the gas from the first stage of the process entering the secondary gasifier is exposed to a high temperature such as to transform essentially all soot present in the gas to CO and to convert essentially all complex organic molecules to simpler molecules CO, CO₂ and H₂. This high temperature to which the gas from the first stage is exposed in the secondary gasifier is usually between 900° C. and 1300° C., preferably around 1100° C., and it is achieved mainly by partial oxidation of the gas from the first stage by injection of predetermined amounts of air, oxygen and/or steam to the eductor, while the plasma torch provides only a small fraction of the energy required for maintaining said high temperature.

The fuel gas exiting the secondary gasifier is normally cooled down very rapidly to a temperature below 100° ° C. so as to freeze the thermodynamic equilibrium of the gas and avoid production of secondary pollutants, and after such cooling, the fuel gas may be subjected to a final cleaning operation to remove any remaining contaminants.

The entire process is preferably carried out under a negative pressure to preclude exit of toxic fumes or of flammable materials from any unit operations. Also, an oxygen starved environment is used in the process to preclude dioxin formation.

The present invention also provides for an apparatus for converting waste having organic and inorganic components into fuel gas, which normally includes:
(a) a primary gasifier comprising a refractory lined, enclosed plasma arc furnace provided with at least one graphite electrode; at least one inlet for feeding waste into the furnace; means for feeding air, oxygen and/or a stem in metered amounts into the furnace; and a gas take off port for primary synthesis gas produced in said primary gasifier; said primary gasifier being adapted to maintain layers of molten metal and molten slag at the bottom of the furnace and on top of the molten slag a layer of partially treated waste over which fresh waste is fed; and said at least one graphite electrode is positioned so as to generate a plasma arc to the molten slag present in the furnace during the operation; and
(b) a secondary gasifier to which the primary synthesis gas is fed, said secondary gasifier being equipped with a plasma-torch fired eductor which ensures that the primary synthesis gas entering from the primary gasifier is exposed to a high temperature such as to transform any soot present in said primary gas into CO and to convert any complex organic molecules to simpler molecules CO, CO₂ and H₂; means for supplying metered amounts of air, oxygen and/or steam into the eductor; said eductor leading to an insulated chamber with a minimal heat loss; and an outlet being provided in said chamber for the fuel gas resulting from the operation.

Preferably, the primary gasifier has two graphite electrodes, one of which creates an are between one electrode and the slag during the operation, and a second arc is created from the slag to the second electrode.

The eductor provided in the secondary gasifier is preferably made of a high heat metal alloy or is refractory lined or water cooled, and is equipped with a plasma torch at its inlet.

The apparatus may further comprise a dust separator, such as a hot cyclone, between the primary gasifier and the secondary gasifier, and a gas quenching and gas cleaning means following the secondary gasifier. It may also be equipped with an induced draft fan adapted to operate the apparatus under a negative pressure.

### BRIEF DESCRIPTION OF THE DRAWINGS

A preferred, non-limitative embodiment of the invention will now be described with reference to the accompanying drawings, in which:

FIG. 1 is a diagrammatic representation of a preferred embodiment of the present invention;

FIG. 2 is an elevation section view of a preferred embodiment of the primary gasifier used within the process and apparatus of the present invention; and

FIG. 3 is an elevation section view of a preferred embodiment of the secondary gasifier used within the process and apparatus of the present invention.

### DESCRIPTION OF THE PREFERRED EMBODIMENT

The process of the present invention can be used to process various types of industrial, hazardous or domestic waste in the form of liquids or solids. The solid wastes can be hospital waste, mixed plastics waste, municipal solid waste, automobile shredder residue or the like. The liquid wastes can be spent solvents, used oils, petroleum sludge, municipal water treatment sludge, de-inking sludge or similar liquids. Normally, the waste will comprise organic and inorganic constituents and in most cases, it will be rich in organic materials. When the waste comprises a combination of solids and liquids, the liquid portion should normally not exceed about 30% by weight of the total.

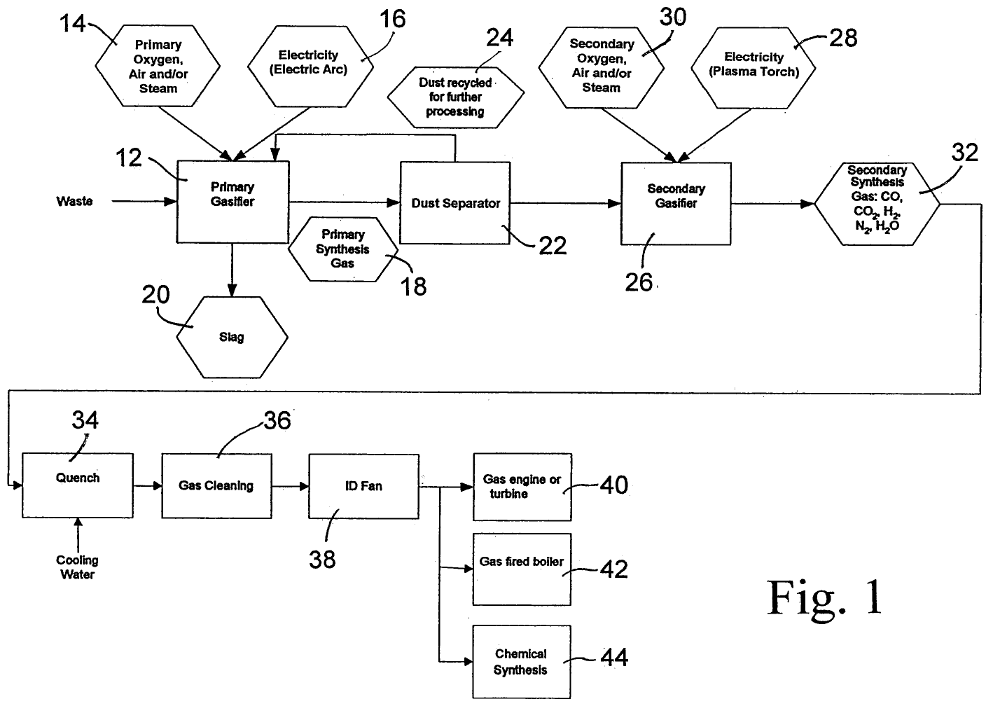

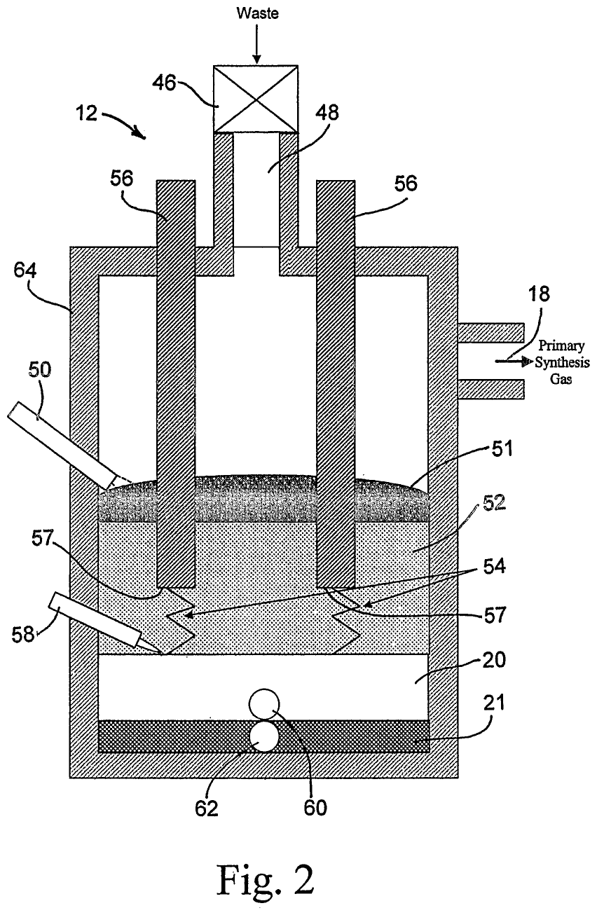

As shown in FIG. 1, the waste is first introduced into a primary gasifier (12) which is a plasma furnace. This plasma furnace is normally a refractory lined, enclosed, graphite arc furnace, where the plasma is generated by one or several direct current electrodes forming an electric arc, generally as shown in FIG. 2. The plasma is generated by the electricity 16 flowing through graphite rods to a bath of liquid inorganic material, usually slag originating from the waste itself. This slag is maintained at a temperature of 1500° C. or more. Any metal (i.e. non oxidized inorganic material) present in the waste forms a distinct layer below the slag layer. This metal layer is also maintained at high temperature of 1500° ° C. or more. When starting the system, the slag can be formed from a previous run or be a common inorganic material such as sand or clay.

The organic material present in the waste reacts with primary air, oxygen and/or steam 14 that is added to the furnace using lances. This process is called gasification. The net result of the gasification process is the production of a combustible gas called primary synthesis gas 18, containing CO, H₂, CO₂ and N₂ if the waste contains nitrogen or when the gasifier is fed with air, since air contains 21% O₂ and 79% N₂ by volume. The primary synthesis gas also contains soot and some complex organic molecules.

Gasification occurs as the results of a series of complex chemical reactions that can be simplified as follows;
C+O₂—>CO₂ (exothermic)
C+H₂O—>CO+H₂ (endothermic)
C+CO₂—>2CO (endothermic)
CO+H₂O—>CO₂+H₂ (exothermic)

Some of the reactions are endothermic and some reactions are exothermic. The amount of oxygen, air and/or steam fed to the gasifier can be adjusted to balance the exothermic and endothermic reactions so as to minimize the amount of electric energy required in the furnace. Contrary to dissociation, gasification with metered amounts of oxygen, air and/or steam requires minimal amounts of electrical energy to produce the synthesis gas.

The slag in the primary gasifier 12 is covered with untreated and partially treated waste, also called a cold top. This cold top serves two purposes. First, since the slag is covered with the relatively cold partially treated waste, the furnace roof and spool are not exposed to the high radiative heat from the slag, reducing heat losses in the furnace and increasing refractory life. Second, the cold top favours the condensation of heavy metals onto the partially treated waste and their subsequent fusion into the slag. The slag 20 is periodically removed from the primary gasifier when required.

However, due to its relatively cold temperatures (700 to 800° C.), the cold top favours the production of complex organic molecules and soot (carbon) in the primary gasifier 12.

In order to trap the large soot particles, a dust separator 22 is installed at the gas outlet of the primary gasifier 12. Dust 24 that is removed by the dust separator 22 is normally returned to the primary gasifier 12 for further processing.

The gas exits the dust separator 22, cleaned of large particulates (generally larger than 10 microns). However, it still contains fine soot particulates and complex organic molecules. A secondary gasifier 26 is used to convert the soot and complex organic molecules to CO, H₂ and CO₂. The secondary gasifier 26 operates using electricity 28 in the form of a plasma torch at a higher temperature than the cold top, namely between 900 and 1300° C. and preferably around 1100° C. At this elevated temperature, the thermodynamic equilibrium between C, CO, CO₂, H₂ and H₂O, favours the formation of CO rather than the formation of C (or soot). Also, at this high temperature, complex organic molecules are converted to simpler molecules CO, CO₂ and H₂. Complex organic molecules such as products of incomplete combustion (PIC) are well known pollutants and could be difficult to burn at lower temperatures. The secondary gasifier 26 ensures that they are converted to the inoffensive CO and H₂ form.

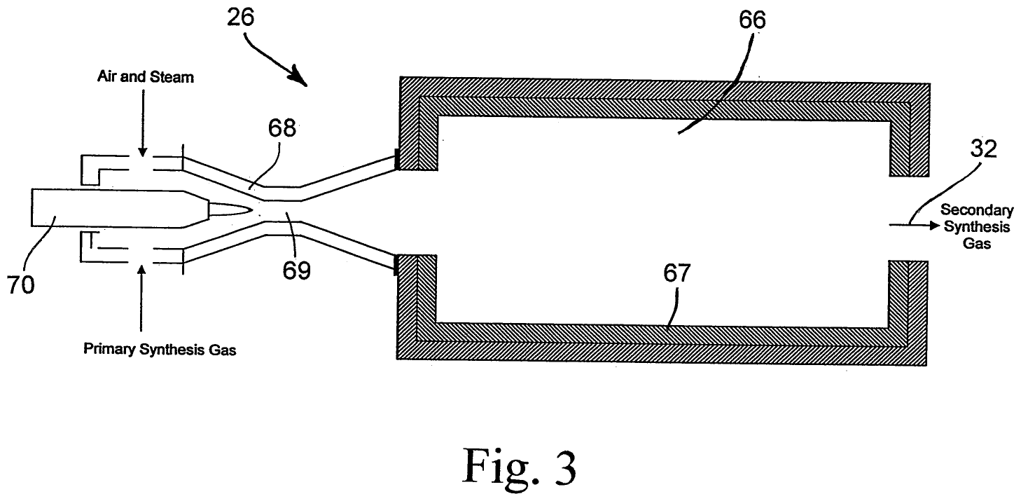

The secondary gasifier 26 is equipped with a plasma-torch fired eductor as shown in FIG. 3. This eductor ensures that all the gas entering the secondary gasifier 26 is exposed to the high heat and the high intensity radiation of the plasma flame.

This ensures essentially complete conversion of all or substantially all the components of the synthesis gas entering the secondary gasifier 26 into simple gaseous molecules of CO, CO₂, H₂ and H₂O.

Two measures are taken in order to ensure high energy efficiency of the secondary gasifier 26. First, the plasma torch 28 provides the activation energy for the conversion reactions, while small metered amount of secondary oxygen, air and/or steam 30 is added, so that the energy required to increase the gas temperature from 800 to 1100° C. is provided mainly by the partial oxidation of the primary synthesis gas 18. Second, the secondary gasifier 26 chamber is insulated with a material such as ceramic wool, in order to ensure minimal heat loss from the chamber.

The synthesis gas 32 exiting the secondary gasifier 26 is then cooled by cooling water using a water quench 34. In the water quench, the gas is cooled very rapidly, in a few milliseconds, from 1100° ° C. to below 100° ° C. This rapid cooling allows to freeze the thermodynamic equilibrium of the gas and, hence, to avoid the production of secondary pollutants such as dioxins and furans. Dioxins and furans are mainly formed from the recombination of chlorine and carbonated compounds (such as CO and CO₂) in the gas. By cooling the gas quickly, this recombination does not have time to occur. The gas is then subjected to gas cleaning 36 which may be a series of known unit operations that will remove remaining contaminants from the gas such as: fine dust, heavy metals, acid gases (hydrogen chloride and hydrogen sulphide), etc.

The whole system is kept under a negative pressure by the use of an induced draft fan 38. This ensures that no toxic fumes can exit the system and that the flammable H₂ and CO stay inside the system, limiting the dangers of fires or explosions. The fan can be of turbine or positive displacement type, depending on gas composition. Gas composition will be a function of operating conditions and type of waste being processed.

The output of the system is clean combustible fuel gas, which can be used for different applications. First, it can be burned in a gas engine or gas turbine 40 for the production of electricity. In that case, cogeneration is also possible: the waste heat from the engine or turbine can be used to produce steam and/or hot water. Depending on system size and waste type, the electricity produced by the engine or turbine may be enough to run the plasma arcs of the primary gasifier 12 and/or the plasma torch of the secondary gasifier 26. The gas can also be used as a source of heat for a boiler 42. In that case, the gas is burned in a standard burner, just as any other commercial gas such as natural gas or liquid petroleum gas (LPG). It can also be used for chemical synthesis 44 as a reaction gas. In all these cases, since the fuel gas has been cleaned essentially of all contaminants, the emissions from the burning or processing of this gas will also be clean of any contaminants.

FIG. 2 illustrates the preferred embodiment of the primary gasifier 12. The solid and liquid wastes are introduced into the primary gasifier 12 as a waste mixture through an isolation valve 46 and into one or multiple feed chutes 48. Alternatively, liquid waste may be fed trough an injection nozzle 50 into partially treated waste 52 inside the furnace. By feeding the liquid waste into relatively cold zones of partially treated waste 52, one ensures that the gasification reactions of the liquid waste are progressive, rather than violent and sudden, which would occur if liquid waste were fed directly on top of the hot slag 20.

The waste is laid over a pool of slag 20 and molten metal 21. The slag and metal are maintained in a liquid state at a temperature of 1500° C. or more by the use of plasma arcs 54 and resistive heating (not shown). The plasma arcs 54 are generated by one or more graphite electrodes 56 that carry DC electric current. Current typically flows from one electrode to the other when more than one electrode 56 is used, creating an arc between one electrode tip 57 and the slag 20, then passing through the highly electrically conductive hot slag 20 and molten metal 21 and creating a second are from the slag 20 to the second electrode tip 57. The electrodes are typically submerged in waste 52, and the plasma arcs 54 are typically covered by waste 52. This favours the passage of current inside the bot slag 20 and molten metal 21, rather than through gas, directly from one electrode to the other. The slag 20 is covered with partially treated waste 52 also referred to as a cold top. Fresh waste 51 is continuously or intermittently added as the gasification reactions in the furnace reduce the volume of waste 52 present.

Waste 52 is heated by plasma arcs 54, which favour the conversion of the organic components of the waste into CO and H₂. This process is referred to as the gasification reactions. Air, oxygen and/or steam are added through a lance 58, in order to favour the gasification reactions in the highest temperature zones of the primary gasifier 12.

The inorganic components of the waste melt and form two distinct layers: a bottom layer of the denser metal 21 and a top layer of the lighter slag 20. Once cooled, this slag 20 becomes a glassy rock, which can be used for construction or other purposes. The rock is non-leaching in nature and allows to trap heavy metals and other contaminants into a glass matrix. Slag 20 and metal 21 can be extracted separately from the furnace through two distinct tap holes 60 and 62.

In the primary gasifier 12, the organic molecules in the waste react with sub-stoichiometric amounts of oxygen, air and/or steam (i.e. less than the oxygen required for complete oxidation of the waste) to form the primary synthesis gas 18. Steam used in the primary gasifier can come from water already present in the waste or be added separately.

The primary synthesis gas 18 is normally composed of combustible CO, H₂ and of non-combustible CO₂ and N₂. Since the slag is covered by partially treated waste or cold top 52, the gases exit the primary gasifier at a relatively low temperature (800° C.). Because of the relatively low temperatures involved in cold top operation, the primary synthesis gas 18 also contains soot and complex organic molecules (such as ethylene, acetylene and aromatic compounds).

The advantage of cold top operation is higher energy efficiency for two reasons: 1) the furnace spool 64 (top section) is kept at a low temperature and 2) the primary synthesis gas 18 exiting the furnace has a lower temperature.

By keeping the spool 64 cold, the radiative heat losses to the roof are much reduced. The radiative heat losses are a function of temperature to the 4^{th} power (q=ϵσ(T₁⁴−T_{Serr}⁴). In consequence, the effect of covering the slag by partially treated waste and reducing its temperature from 1500° C. to 800° C. produces a reduction in radiative heat loss of about 10 times.

Reducing the temperature of the primary synthesis gas 18 also reduces the sensible heat of the gas exiting the furnace and, therefore, the sensible beat carried out of the furnace.

Another advantage of the cold top operation is to limit entrainment of particulates. Because the fresh waste 51 falls on a relatively cold surface of the waste 52 being processed, the gasification reactions are less violent and happen in stages as the waste progresses down from cold top temperature to reaction temperature of 1500° C. at the slag 20 surface.

A still further advantage of cold top operation is to minimize the volatilization of metals, volatilized metals at the high slag temperature condense on the cold waste particles and have a better chance of being trapped in the slag.

Due to the lower temperatures on the top of the reactor, some waste will exit the reactor unreacted or partially reacted. For example, some oil waste will vaporize before being completely dissociated into CO and H₂. The thermodynamic equilibrium under the reducing conditions of the furnace favour the production of carbon soot at the relatively low temperature at the outlet of the furnace (800° C.). A secondary gasifier 26 working at around 1100° C. is used to convert any remaining complex organics in the primary syngas to CO and H₂. It is shown in FIG. 3 of the drawings. The carbon soot is converted to CO by the addition of oxygen, air and/or steam to the secondary gasifier. At 1100° C., thermodynamic equilibrium, under reducing conditions, favours the production of CO, rather than soot (C).

The use of the secondary gasifier 26 also gives the option of controlling the chemistry of the fuel gas or secondary synthesis gas 32 produced by the system, without affecting the operation of the primary gasifier 12 (dust entrainment, electrode erosion, slag volatilisation). For example, adding steam into the secondary gasifier 26 will tend to increase the amount of hydrogen present in the secondary synthesis gas 32, while reducing the amount of carbon soot and carbon monoxide.

The secondary gasifier 26 includes a high temperature chamber 66, equipped with a gas mixer or eductor 68 at the chamber inlet. The inside walls of the eductor 68 can have different construction: refractory-lined, water-cooled, or high heat metal alloy. The eductor is equipped with a plasma torch 70 at the inlet. The eductor 68 provides a suction effect on the primary synthesis gas and favours intimate contact of the soot particles and complex organic molecules with the plasma flame in the eductor throat 69. The high temperature chamber is insulated with insulation 67 in order to ensure minimal heat loss from the chamber.

The present invention is not limited to the specific embodiments described above, but may comprise various modifications obvious to those skilled in the art without departing from the invention and the scope of the following claims.

We claim:

1. A two-stage plasma process for converting waste having organic and inorganic components into fuel gas, which comprises:
(a) in the first stage, vitrifying or melting the inorganic components of the waste and partially gasifying the organic components; and
(b) in the second stage, completing the gasification of the organic components so that gas from the first stage of the process entering the secondary gasifier is exposed to a high temperature such as to transform essentially all soot present in the gas to CO and to convert essentially all complex organic molecules to simpler molecules CO, CO₂ and H₂, wherein a dust separation and removal step is provided between the first and second stages of the process.

2. A process according to claim 1, in which the fuel gas produced in the second stage is quenched and cleaned to make it suitable for use in a gas engine or turbine for production of electricity or in a gas burner for production of steam or in chemical synthesis reactions.

3. A process according to claim 1, in which the first stage is carried out in a plasma arc furnace.

4. A process according to claim 1, in which the second stage is carried out in a secondary gasifier using a plasma torch with addition of metered amounts of oxygen, air and/or steam.

5. A process according to claim 3, in which the plasma arc furnace is a refractory lined, enclosed furnace provided with at least one direct current graphite electrode adapted to generate a plasma arc to a bath of liquid inorganic material originating from the waste itself and located at the bottom of the furnace.

6. A process according to claim 5, in which said liquid inorganic material comprises a slag layer which is maintained at a temperature of at least 1500° C.

7. A process according to claim 6, in which said liquid inorganic material further comprises a metal layer also maintained at a temperature of at least 1500° C. and located under the slag layer.

8. A process according to claim 5, in which the waste is introduced into the furnace on top of the liquid inorganic material and the organic component in the waste reacts with air, oxygen and/or steam supplied to the furnace in a predetermined amount adapted to achieve gasification of organic material in the waste into a primary synthesis gas containing CO, H₂, CO₂ and N₂ if the waste contains nitrogen or if air is added to the furnace, and also containing some soot and complex organic molecules.

9. A process according to claim 8, in which the organic material in the waste is so reacted as to form a layer of partially treated waste on top of the slag layer and fresh waste is introduced into the furnace on top of said partially treated waste layer which is maintained at a temperature of between 700 and 800° C. and constitutes a cold top for the fresh waste added to the furnace.

10. A process according to claim 1, in which in the first stage, the organic component in the waste reacts with air, oxygen and/or steam supplied to the furnace to achieve gasification of organic material in the waste into a primary synthesis gas containing CO, H₂, CO₂ and N₂ if the waste contains nitrogen or if air is added to the furnace, and also containing some soot and complex organic molecules, and wherein the primary synthesis gas is subjected to the dust separation and removal step in which dust particles larger than a predetermined size are separated and removed.

11. A process according to claim 10, in which the removed dust particles are recycled to the first stage.

12. A process according to claim 4, in which the secondary gasifier is equipped with a plasma torch fired eductor for exposing the gas from the first stage of the process entering the secondary gasifier to a high temperature.

13. A process according to claim 12, in which the high temperature to which gas from the first stage is exposed in the secondary gasifier is between 900° C. and 1300° C.

14. A process according to claim 13, in which the high temperature is achieved mainly by partial oxidation of the gas from the first stage by injection of predetermined amounts of air, oxygen and/or steam to the eductor, and the plasma torch provides only a small fraction of the energy required for maintaining said high temperature.

15. A process according to claim 12, in which the fuel gas exiting the secondary gasifier is cooled down very rapidly to a temperature below 100° C. so as to freeze the thermodynamic equilibrium of the fuel gas and avoid production of secondary pollutants.

16. A process according to claim 15, in which after cooling, the fuel gas is subjected to a final cleaning operation to remove any remaining contaminants.

17. A process according to claim 1, in which the process is carried out under a negative pressure to preclude exit of toxic fumes or of flammable materials from any unit operations.

18. A process according to claim 1, in which an oxygen starved environment in used in the process to preclude dioxin formation.

19. Apparatus for converting waste having organic and inorganic components into fuel gas, which includes:
(a) a primary gasifier comprising a refractory lined, enclosed plasma arc furnace provided with at least one graphite electrode; at least one inlet for feeding waste into the furnace; means for feeding air, oxygen and/or steam in metered amounts into the furnace; and a gas take off port for primary synthesis gas produced in said primary gasifier; said primary gasifier being adapted to maintain layers of molten metal and molten slag at the bottom of the furnace and on top of the molten slag a layer of partially treated waste on top of which fresh waste is fed; and said at least one graphite electrode being adapted to generate a plasma arc to the molten slag present in the furnace during the operation; and
(b) a secondary gasifier to which the primary synthesis gas is fed, said secondary gasifier being equipped with a plasma-torch fired eductor adapted to expose the primary synthesis gas entering from the primary gasifier to a high temperature such as to transform essentially any soot present in said primary gas into CO and to convert essentially any complex organic molecule to simpler molecules CO, CO₂ and H₂; means for supplying metered amounts of air, oxygen and/or steam into the eductor; said eductor leading to an insulated chamber; and an outlet being provided in said chamber for the fuel gas resulting from the operation, wherein a dust separator is provided between the primary gasifier and the secondary gasifier.

20. Apparatus according to claim 19, in which in the primary gasifier two graphite electrodes are used creating an arc between one electrode and the slag during the operation, and creating a second arc from the slag to the second electrode.

21. Apparatus according to claim 19, in which the eductor provided in the secondary gasifier is made of a high heat metal alloy or is refractory lined or water cooled, and is equipped with the plasma torch at its inlet.

22. Apparatus according to claim 19, wherein dust particles removed by the dust separator provided between the primary gasifier and the secondary gasifier are recycled to said furnace of the primary gasifier.

23. Apparatus according to claim 19, further comprising a gas quenching and gas cleaning means following the secondary gasifier.

24. Apparatus according to claim 19, further comprising an induced draft fan adapted to operate the apparatus under a negative pressure.

25. A process according to claim 11, in which the first stage is carried out in a plasma arc furnace.
